(19) United States
(12) Patent Application Publication
(10) Pub. No.: US 2020/0023212 A1
(43) Pub. Date: Jan. 23, 2020

(54) FIRE FIGHTING DEVICE

(71) Applicant: Everet Duklair S.r.l., Levico Terme (IT)

(72) Inventors: Guido DALL'AGNOL, Levico Terme (IT); Daniele BONOTTO, Levico Terme (IT); Stefano BONOTTO, Levico Terme (IT)

(73) Assignee: Everet Duklair S.r.l., Levico Terme (IT)

(21) Appl. No.: 16/337,948

(22) PCT Filed: Sep. 29, 2017
(86) PCT No.: PCT/IT2017/000210

§ 371 Date: Mar. 29, 2019

(30) Foreign Application Priority Data
Sep. 30, 2016 (IT) 102016000098057

(51) Int. Cl. A62C 2/06; A62C 3/16; A62D 1/00

(52) U.S. Cl. CPC A62C 2/065; A62D 1/0028; A62C 3/16

(57) ABSTRACT

A fire extinguishing device, comprising a support or base substrate, resistant to high temperatures and capable of being folded and/or shaped in three-dimensional form, on which, a predetermined thickness and preferably between 0.3 mm and 3 mm, a first homogeneous mixture comprising expanding graphite in a quantity of between 10% and 45%, a mono-component adhesive in a quantity between 45% and 75%, and other additives suitable to hinder the fire in a quantity between 1′1% and 20% or a second homogeneous mixture containing intumescent paint in a quantity between 70% and 95% and other additives suitable to hinder the fire in a quantity between 5% to 30% is deposited.

The present invention generally refers to a fire extinguishing device and, more particularly, refers to an expandable laminate foil (provided with or without an intumescent paint) applicable, advantageously, to electrical appliances.

In any case, the device finds application in several situations where excessive heating of a contact, junction or electrical element may arise, that can trigger a fire, by activating a type of an active protection against the fire, as it aims to reduce the effects of the fire, locating it and containing it through an early detection, rapid control and, in most part of the cases, consequent extinction.

The process works autonomously, without any energy input for its activation, as it uses the same energy of the ignition and the fire.

The traditional fire extinguishing devices consist of systems that tend to delay the development of the fire (for example, there are still known REI regulations for fire resistance) and systems that actively intervene in fire extinguishing; however, their intervention is generally late, as they are activated when the fire has propagated and major damage to the premises and their contents has already occurred.

Other solutions provide the use of flame retardant additives, which are, however, usually used for electric appliances such as coffee machines or ice cream machines, and/or the construction of plastic casings made with anti-flame polymers, designed to secure electrical panels, printed circuits, power supplies, transformers, etc.

However, the use of anti-flame polymers generate high costs due to the notable costs of the raw material, which determine, in turn, a consistent increase in the production costs of the finished product; moreover, their composition are less suitable to stamping operations, making them more difficult to produce and, finally, it is not possible to reuse the scraps from their machining, which are then sold with difficulty and low price.

Last but not least, obtaining obligatory certifications carries additional costs.

In addition, the use of chemical retardants for flames are limited to the propagation of a flame, or put a stop to it only for very short times; this means that in the case in which the equipment or the electrical panel is in a non surveillance environment, the fire can propagate in anyway undisturbed.

In the ambit of the needs mentioned, therefore, the main scope of the present invention is to overcome the drawbacks of the prior art and, in particular, to provide a fire extinguisher, which reduces the effects of a fire by locating it and containing it by means of its early detection and rapid control, in way that it can be quickly extinguished.

Another object of the present invention is to provide a fire extinguishing device, which operates efficiently and safely and does not require flame retardant additives.

Another object of the present invention is to provide a fire extinguishing device, which exhibits a low production cost over known devices.

These and other objects, which will be most apparent in the following discussion, are obtained according to the invention by means of a fire extinguishing device according to claim 1; further specific technical details are reported in subsequent dependent claims.

Advantageously, the fire extinguishing device, which is the object of the present invention, applies preferably to electrical appliances and comprises substantially a laminate foil equipped with expanding material (in which the expanding part may constitute an intumescent paint), which can be used whether or not assembled to other foil/structures, by means of gluing, mechanical fastening, metallic wire stitching, organic, inorganic or stapling, zip ties or various bindings, and as well as buttons, only in support, wrapped around and preformed for drawing.

In addition, if a partial activation of the device occurs, the same device may be replaced with a new one.

The main function of the device is to hinder the fire process and its propagation, to achieve a complete quenching of any outbreak of fire.

Further features and advantages of the present invention will be more apparent from the following description, referring to a preferred embodiment but not limitative of the fire extinguishing device, object of the invention.

This fire extinguishing device is substantially made up of a support or base substrate (preferably resistant to high temperature), suitable to be folded and/or shaped in three-dimensional form even customizable, for example through a pre-forming process; the support or base substrate consists preferably of fabric, glass fabric, ceramic paper, refractory compounds, rubber and plastic polymers in general, one or more metal laminate foil and/or metal meshes.

A coat, paint or spray of a compound that activates, when a fire starts, in its vicinity, so as to contain and extinguish any outbreak of fire; this compound acts preferably expanding and hindering the combustion reaction of the fire and, if well dimensioned, rapidly causes the fire to be quenched.

The compound, suitably mixed in way homogeneous at a temperature preferably between 22° C. and 32° C., is deposited for a thickness that can vary from 0.3 mm to 3 mm and includes the following components:

1. expanding graphite, in an quantity between 10% and 45%;

2. mono-component adhesive (with reaction to fire according to the regulation UNI 9177/87 of class 1), in an quantity between 35% and 75%;

3. Other additives suitable to hinder the fire, in an quantity between 1′1% to 20%.

In alternative embodiments, this compound is made up of a mixture, which is also perfectly homogeneous and prepared at a temperature of preferably between 22° C. and 32° C., which can be painted or sprayed on the base support and includes the following components:

1. intumescent paint, in a quantity between 70% and 95%;

2. Other additives suitable to hinder the fire, in a quantity between 5% and 30%.

At the end of the deposition of the compound or mixture, a sufficient drying time is expected for the stabilization and, therefore, the laminate final product can be punched or cut with various systems or can be sewn, fixed with stapling, with wire stitching (organic or inorganic), glued, melted and/or secured by means of clips, screws, studs, rivets, rivets and any mechanically fixed or removable mechanical anchorage system or simply rolled.

In use, the laminate fireproof foil according to the invention is shaped like a kind of container placed around the space corresponding to the point of the potential trigger; this space can be partially or completely closed, in a way such that, in the case of fire outbreak, the laminate foil chokes the combustion and stops the propagation of the fire, retaining it within the created structure.

Preferably, the laminate fireproof foil is applied in the most adherent way possible to the potential trigger component, so as to choke and quench the starting fire before it propagates to the outside.

Thus, in the presence of excessive heat, the substance agent expands by suffocating the combustion, as it releases gases capable of inhibiting combustion by acting on the combustion reaction chain.

Advantageously, the laminate fireproof foil can be made impermeable and sealed or can be permeable and not completely closed so as to allow air or fluid to pass (for example, if it is advantageous to have a heat dissipation and obtain a adequate ventilation using the resulting “chimney effect”).

From the description, the features of the fire extinguishing device, which is the object of the present invention is made clear, as well as the advantages thereof.

It is clear, at the end, that numerous other variants can be made to the fire extinguishing device in question, without departing from the novelty principles inherent in the inventive idea of the attached claims, as it is clear that, in the practical implementation of the invention, the materials, the shapes and dimensions of the details shown may be any, according to the needs and the same can be replaced with other technically equivalent ones.

1. A fire extinguishing device comprising a support or base substrate, resistant to high temperatures and capable of being folded, glued and/or shaped in three-dimensional form, on which, for a predetermined thickness and preferably between 0.3 mm and 3 mm, a first homogeneous mixture containing graphite expanding in a quantity between 10% and 45%, mono-component adhesive in a quantity between 35% to 75% and other additives suitable to hinder the fire in a quantity between 1′1% and 20%, or a second homogeneous mixture containing intumescent paint in a quantity between 70% and 95% and other additives suitable to hinder the fire in a quantity between 5% to 30%, is deposited.

2. A fire extinguishing device as claimed in claim 1, characterized in that said support or base substrate is made up of fabric, glass fabric, ceramic paper, refractory compounds, rubber and plastic polymers in general.

3. A fire extinguishing device as claimed in claim 1, characterized in that said support or base substrate is made up by one or more metallic laminate foil and/or metal meshes.

4. A fire extinguishing device as claimed in claim 1, characterized in that said mixture is coated, painted or sprayed onto said support or base substrate.

5. A fire extinguishing device as claimed in claim 1, characterized in that said device, after a drying phase, is punched or cut into prefixed formats and sizes or sewn, secured with stapling, with wire stitching, glued, melted and/or fastened by means of clips, screws, studs, rivets, rivets and any mechanical anchorage system, fixed or removable, to the device to be controlled.

6. A fire extinguishing device as claimed in claim 1, characterized in that said device is shaped like a container and placed in a space around the device to be controlled.

7. A fire extinguishing device as claimed in claim 6, characterized in that said space is partially or completely closed.

8. A fire extinguishing device as claimed in claim 1, characterized in that said device is applied in a way substantially adherent to the device to be controlled.

9. A fire extinguishing device as claimed in claim 1, characterized in that said support or base substrate is impermeable and sealed or permeable and open at least partially so as to obtain heat dissipation and adequate ventilation.
